(19) United States
(12) Patent Application Publication
(10) Pub. No.: US 2009/0193335 A1
(43) Pub. Date: Jul. 30, 2009

(54) DOCUMENT MANAGEMENT DEVICE, DOCUMENT MANAGEMENT METHOD, COMPUTER READABLE RECORDING MEDIUM AND DATA SIGNAL

(75) Inventors: Hironori TANAKA, Kanagawa (JP); Takahiro SAITO, Kanagawa (JP); Shintaro KOJO, Kanagawa (JP); Yukio IIJIMA, Kanagawa (JP); Hajime ICHIDA, Kanagawa (JP); Yuka AOKI, Tokyo (JP); Noriyuki KAJITANI, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/356,634

(22) Filed: Jan. 21, 2009

(30) Foreign Application Priority Data
Jan. 24, 2008 (JP) 2008-13709

(51) Int. Cl. G06F 17/00

(52) U.S. Cl. 715/273

(57) ABSTRACT

A document management device, which includes: a document receptor that receives a document; a pattern information generator that generates first information on which a first background pattern image is based; an addition section that adds the first information to the document; a setter that sets, to the document, a prohibition on editing the first information; a document storage that stores the document having the first information added thereto; a printing request receptor that receives a printing request; an prohibition lifting section that lifts the prohibition; an edition section that edits the first information to make second information on which a second background pattern image is based; a printing image generator that generates a printing image having the second background pattern image incorporated thereinto; and a sender that sends, to an image formation device, the printing image having the second background pattern image incorporated thereinto.

### CROSS-REFERENCE TO RELATED APPLICATION

This application is based on and claims priority under 35 USC 119 from Japanese Patent Application No. 2008-13709 filed on Jan. 24, 2008.

### BACKGROUND

1. Technical Field

The present invention relates to a document management device, a document management method, a computer readable recording medium and a data signal.

2. Related Art

Recently, with the increasing awareness of document security, there have been developed techniques for attaching a copy deterrent pattern (hereinafter, referred to as background pattern image) to a printing result formed by an image formation device such as a printer.

### SUMMARY

An aspect of the present invention provides a document management device, which includes: a document reception section that receives a document from a requestor through a communication section; a background pattern information generation section that generates first background pattern information on which a first background pattern image is based; a background pattern information addition section that adds the first background pattern information generated by the background pattern information generation section to the document received by the document reception section; an edition prohibition setting section that sets, to the document, a prohibition on editing the first background pattern information added by the background pattern information addition section; a document storage that stores the document having the first background pattern information added thereto; a printing request reception section that receives, through the communication section from a requester, a request that an image formation device prints out the document stored in the document storage; an edition prohibition lifting section that lifts the prohibition on editing the first background pattern information set to the document, which is an object of the request for printing received by the printing request reception section; an edition section that edits the first background pattern information added to the document in which editing prohibition is lifted by the edition prohibition lifting section to make second background pattern information on which a second background pattern image is based; a printing image generation section that generates a printing image having the second background pattern image incorporated thereinto, on the basis of the document having the second background pattern information edited by the edition section added thereto; and a printing image sending section that sends, through the communication section to the image formation device, the printing image that is generated by the printing image generation section and into which the second background pattern image is incorporated.

### BRIEF DESCRIPTION OF THE DRAWINGS

An exemplary embodiment of the present invention will be described in detail based on the following figures, wherein:

FIG. 1 is a diagram illustrating one example of an overall configuration of a document management system;

FIG. 2 is a diagram illustrating one example of a functional configuration of a document management device;

FIG. 3 is a diagram for explaining functional operations of the document management device at the time of document registration;

FIGS. 4A and 4B are diagrams each showing one example of a structure of a document stored in a document storage;

FIG. 5 is a flow chart showing one example of a process flow performed in the document management device at the time of document registration;

FIG. 6 is a diagram for explaining functional operations of the document management device at the time of document acquisition;

FIG. 7 is a diagram showing one example of a document sent from a document sending section to a PC;

FIG. 8 is a flow chart showing one example of a process flow performed in the document management device at the time of document acquisition;

FIG. 9 is a diagram for explaining functional operations of the document management device at the time of document printing;

FIG. 10 is a diagram showing one example of a document sent from a printing image sending section to a printer; and

FIG. 11 is a flow chart showing one example of a process flow performed in the document management device at the time of document printing.

### DETAILED DESCRIPTION

Hereinafter, an exemplary embodiment of a document management device, a document management method, a computer readable recording medium and a data signal according to the present invention will be described in detail with reference to the attached drawings.

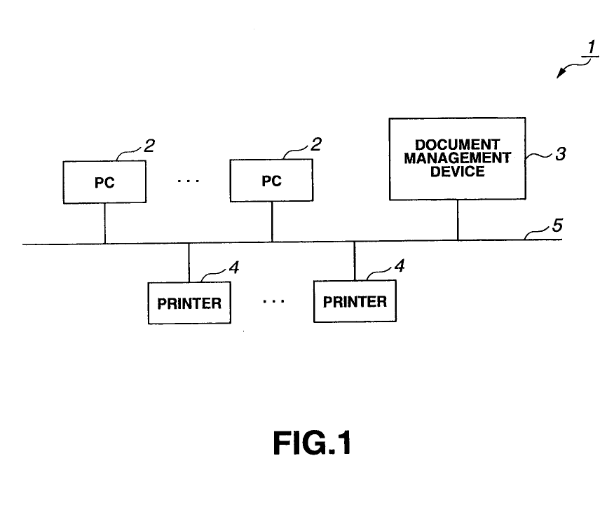

FIG. 1 is a diagram showing one example of an overall configuration of a document management system 1.

As shown in FIG. 1, the document management system 1 includes one or more personal computers 2 (hereinafter referred to as PC) handled by a user, a document management device 3 that manages text files, binary files or other files (hereinafter, referred to as document), and one or more printers 4 that print out documents. Those devices are connected with each other through a network 5 such as LAN (Local Area Network).

In the document management system 1, the document management device 3 stores a document sent from the PC 2 (document registration), the PC 2 acquires the document registered in the document management device 3 (document acquisition), and the printer 4 prints out the document registered in the document management device 3 (document printing).

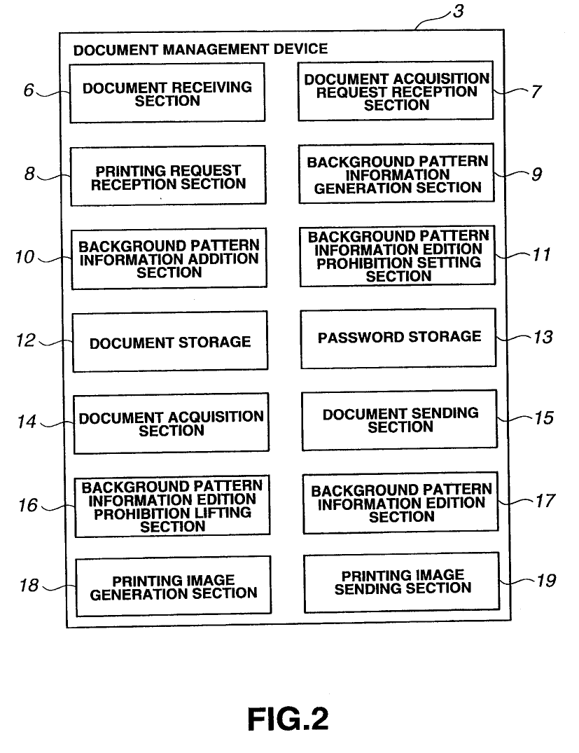

FIG. 2 is a diagram showing one example of a functional configuration of the document management device 3.

As shown in FIG. 2, the document management device 3 includes a document receiving section 6, a document acquisition request reception section 7, a printing request reception section 8, a background pattern information generation section 9, a background pattern information addition section 10, a background pattern information edition prohibition setting section 11, a document storage 12, a password storage 13, a document acquisition section 14, a document sending section 15, a background pattern information edition prohibition lifting section 16, a background pattern information edition section 17, a printing image generation section 18, and a printing image sending section 19.

The document receiving section 6 receives the document (the document subject to document registration) sent from the PC 2.

The document acquisition request reception section 7 receives a document acquisition request from the PC 2.

The printing request reception section 8 receives a document printing request from the PC 2 or the printer 4.

Upon receiving the document by the document receiving section 6, the background pattern information generation section 9 generates information on which a background pattern image is based (hereinafter, referred to as background pattern information). Note that the background pattern information generated by the background pattern information generation section 9 is information indicating that the document is not an official document.

The background pattern information addition section 10 adds the background pattern information generated by the background pattern information generation section 9 to the document received by the document receiving section 6.

The background pattern information edition prohibition setting section 11 sets prohibition on editing the background pattern information added to the document by the background pattern information addition section 10. Note that, as the setting for prohibiting the edition of the background pattern information, a configuration in which authentication information for protecting the background pattern information (hereinafter, referred to as password) is generated, and the password is added to the document is employed. By generating the password so as to contain a value that cannot be inputted from a keyboard or other devices of the PC, it becomes difficult to lift the prohibition on editing the background pattern information.

The document storage 12 is a storage area that stores the document to which the background pattern information and the password are added.

The password storage 13 is a storage area that stores the password in association with the document. Note that it may be possible to employ a configuration in which the password is not stored in the password storage 13.

Upon receiving, by the document acquisition request reception section 7, a document acquisition request from the PC 2, the document acquisition section 14 acquires the document, which is an object of the document acquisition request, from the document storage 12. Alternatively, upon receiving, by the printing request reception section 8, a document printing request from the PC 2, the document acquisition section 14 acquires the document-to-be-printed from the document storage 12.

The document sending section 15 sends the document, which is the object of the document acquisition request and is acquired by the document acquisition section 14, to the PC 2, which is a requester of the document acquisition request.

Upon receiving, by the printing request reception section 8, the document printing request from the PC 2, the background pattern information edition prohibition lifting section 16 lifts the prohibition on editing the background pattern information added to the document-to-be-printed acquired by the document acquisition section 14. Note that, to lift the prohibition on editing the background pattern information, the password for protecting the background pattern information is acquired from the password storage 13, and the protection for the background pattern information is made ineffective by using the password. Note that, in the case of not storing the password in the password storage 13, a user sends a password from the PC 2 to the document management device 3, and the protection for the background pattern information is made ineffective by using the password sent.

The background pattern information edition section 17 edits the background pattern information for which edition prohibition is lifted by the background pattern information edition prohibition lifting section 16. Note that the background pattern information edited by the background pattern information edition section 17 indicates that the document is an official document. The background pattern information may be information stored in the document management device, or information received from the PC.

The printing image generation section 18 generates data in a PDL format or other formats (hereinafter, referred to as printing image) interpretable by the printer 4 on the basis of the document whose background pattern information is edited by the background pattern information edition section 17. It also generates a background pattern image on the basis of the background pattern information, and incorporates the generated background pattern image into the printing image.

The printing image sending section 19 sends, to the printer 4 that prints out the document, the printing image into which the background pattern image generated by the printing image generation section 18 is incorporated.

Note that it may be possible to employ a configuration in which a document management program having functions of the document receiving section 6, the document acquisition request reception section 7, the printing request reception section 8, the background pattern information generation section 9, the background pattern information addition section 10, the background pattern information edition prohibition setting section 11, the document acquisition section 14, the document sending section 15, the background pattern information edition prohibition lifting section 16, the background pattern information edition section 17, the printing image generation section 18, and the printing image sending section 19 described above is installed in a general-purpose computer or a server. In this configuration, the document management program is stored in a storage of the computer or the server, and a CPU of the computer or the server executes the document management program stored in the storage. Additionally, it may be possible to provide the document management program by storing the program in, for example, a recording medium such as various memories, optical disk, or to distribute the program through, for example, the communication lines such as a network.

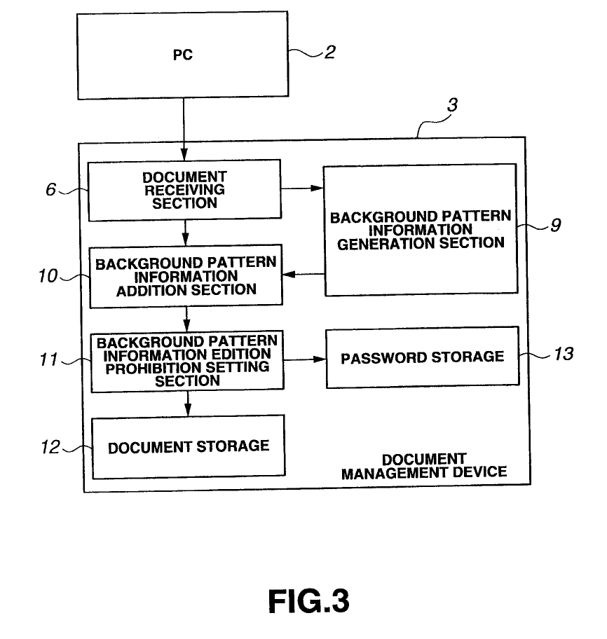

Next, functions and operations by the document management device 3 at the time of document registration will be described with reference to FIG. 3.

The PC 2 sends a document-to-be-registered to the document management device 3.

Upon receiving the document from the PC 2, the document receiving section 6 transfers the document to the background pattern information addition section 10.

The background pattern information generation section 9 generates background pattern information, and transfers the generated background pattern information to the background pattern information addition section 10.

Upon receiving the document and the background pattern information, the background pattern information addition section 10 adds the background pattern information to the document, and transfers the document having the background pattern information added thereto to the background pattern information edition prohibition setting section 11. After receiving the document to which the background pattern is added, the background pattern information edition prohibition setting section 11 generates a password for protecting the background pattern information, and adds the password to the document. Here, for the password added by the background pattern information edition prohibition setting section 11, it may be possible to employ a password for protecting not only the background pattern information, but also the content of the document including the background pattern information.

The document storage 12 stores the document to which the background pattern information and the password are added, and the password storage 13 stores the password in association with the document.

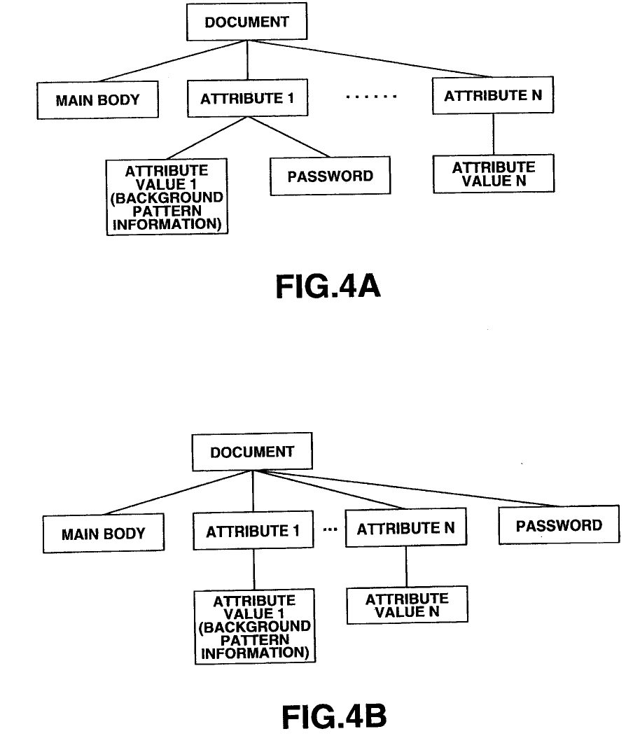

FIGS. 4A and 4B are diagrams each showing one example of a structure of the document stored in the document storage 12.

As shown in FIG. 4A, the document includes a main body and plural attributes (attribute 1 through attribute N in FIG. 4A). To each of the attributes, an attribute value is set (in FIG. 4A, an attribute value 1 is set to the attribute 1, while an attribute value N is set to the attribute N). Additionally, as the attribute value set to the attribute of the document received by the document receiving section 6, the background pattern information is set (in FIG. 4A, the background pattern information is set as the attribute value 1 of the attribute 1). The password for protecting this background pattern information is set in association with the background pattern information (in FIG. 4A, the password is set to the attribute 1). Note that, as shown in FIG. 4A, it may be possible that there exists an attribute (attribute N in FIG. 4A) that does not have any password set therein.

As shown in FIG. 4B, it may be possible to set a password that collectively protects plural attribute values such that the password is directly set to the document.

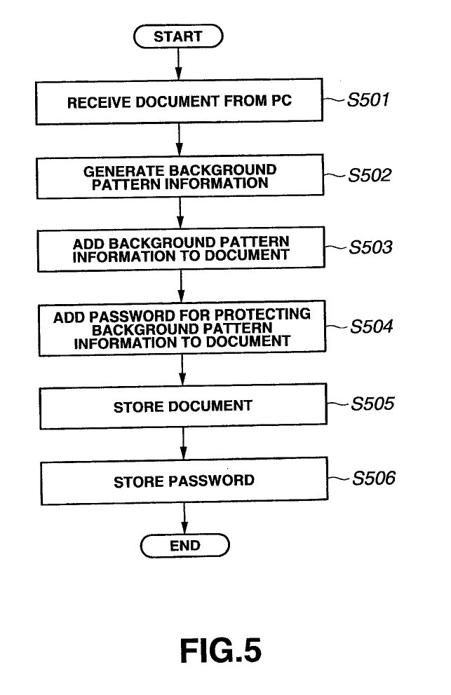

Next, an example of a flow processed by the document management device 3 at the time of document registration will be described with reference to a flow chart shown in FIG. 5.

When the document receiving section 6 receives the document from the PC (S501), the background pattern information generation section 9 generates the background pattern information (S502), the background pattern information addition section 10 adds the background pattern information to the document (S503), the background pattern information edition prohibition setting section 11 adds the password for protecting the background pattern information to the document (S504), the document storage 12 stores the document to which the background pattern information and the password are added (S505), the password is stored in the password storage 13 (S506), and the process ends.

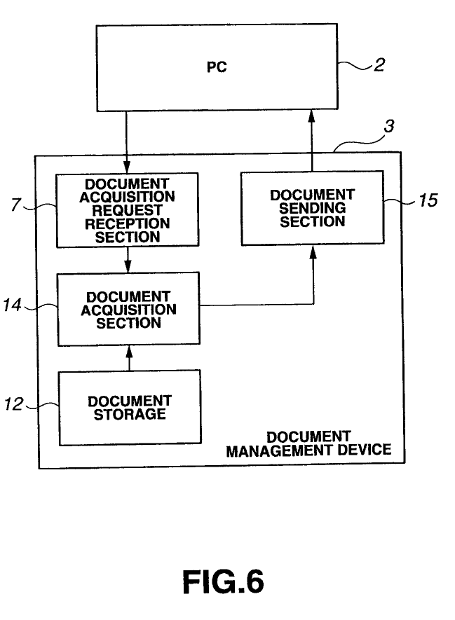

Next, functions and operations by the document management device 3 at the time of document acquisition will be described with reference to FIG. 6.

The PC 2 makes a request to the document management device 3 for document acquisition.

When the document acquisition request reception section 7 receives the request for document acquisition from the PC 2, the document acquisition section 14 acquires a document, which is an object of the request, from the document storage 12, and transfers the document to the document sending section 15. Upon receiving the document, the document sending section 15 sends the document to the PC 2.

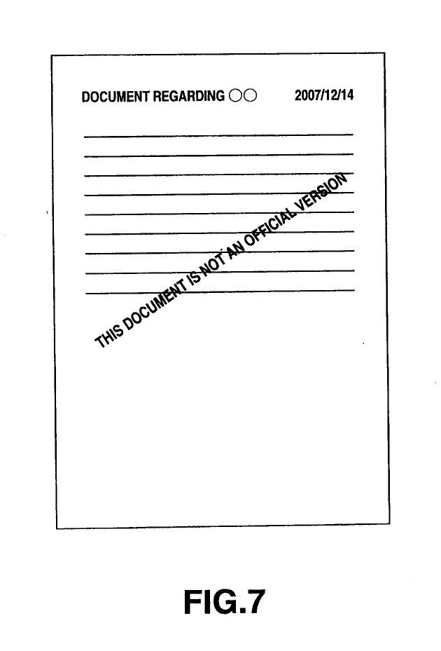

FIG. 7 is a diagram showing one example of the document sent from the document sending section 15 to the PC 2.

In a case where the document acquisition request reception section 7 receives from the PC 2 the request for document acquisition, the document management device 3 directly sends the document to the PC 2 without lifting the prohibition on editing the background pattern information added to the document, which is the object of the request and is acquired from the document storage 12. As the background pattern information of the document sent to the PC 2 is information indicating that this document is not an official document, a background pattern image indicating, as shown in FIG. 7, that the document is not an official version is printed if the document is printed out directly by the printer, etc.

Viewing this document, a user can understand that there is a probability that the document is edited with the PC 2 after the PC 2 acquires the document from the document management device 3.

Note that the background pattern image may be in a form of visible stamp image, may be in a form of latent image in which a specific character string appears by copying, may be in a form of machine readable code, or may be in a form where the background pattern information is recorded in an electronic tag such as RFID.

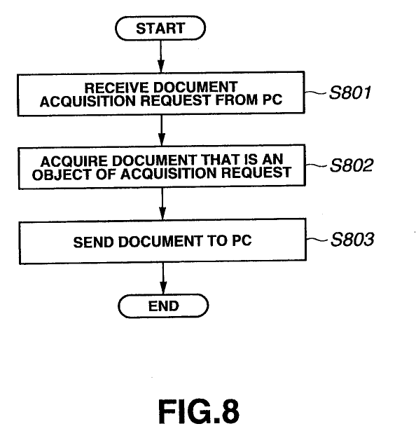

Next, one example of a flow processed by the document management device 3 at the time of document acquisition will be described with reference to a flow chart shown in FIG. 8.

Once the document acquisition request reception section 7 receives from the PC the document acquisition request (S801), the document acquisition section 14 acquires the document, which is an object of the document acquisition request, from the document storage 12 (S802), the document sending section 15 sends the document to the PC (S803), and the process ends.

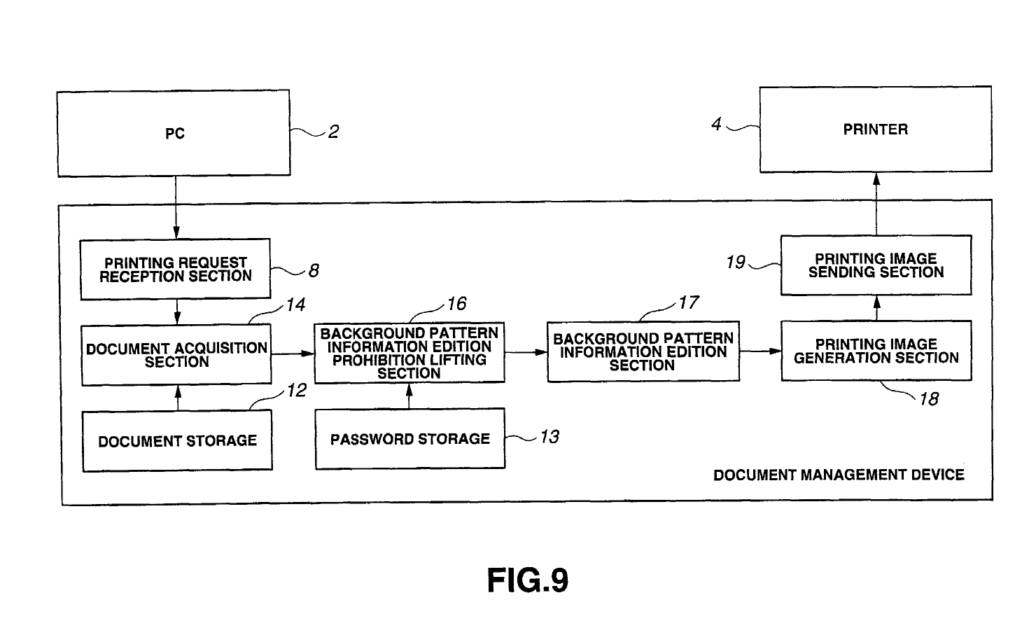

Next, functions and operations by the document management device 3 at the time of document printing will be described with reference to FIG. 9.

The PC 2 makes a request for document printing to the document management device 3. Note that it may be possible that the request for document printing to the document management device 3 is made by the printer 4.

Once the printing request reception section 8 receives from the PC 2 the request for document printing, the document acquisition section 14 acquires from the document storage 12 the document-to-be-printed, and transfers the document to the background pattern information edition prohibition lifting section 16. Upon receiving the document, the background pattern information edition prohibition lifting section 16 acquires from the password storage 13 the password for protecting the background pattern information added to the document, lifts the prohibition on editing the background pattern information with the password, and transfers to the background pattern information edition section 17 the document in which the prohibition on editing the background pattern information is lifted. Upon receiving the document in which the prohibition on editing the background pattern information has been lifted, the background pattern information edition section 17 edits the background pattern information, and transfers to the printing image generation section 18 the document in which the background pattern information has been edited. Upon receiving the document, the printing image generation section 18 generates a printing image on the basis of the document, generates a background pattern image on the basis of the background pattern information added to the document, incorporates the background pattern image into the printing image, and transfers the printing image having the background pattern image incorporated thereinto to the printing image sending section 19. Upon receiving the printing image, the printing image sending section 19 sends the printing image to the printer 4.

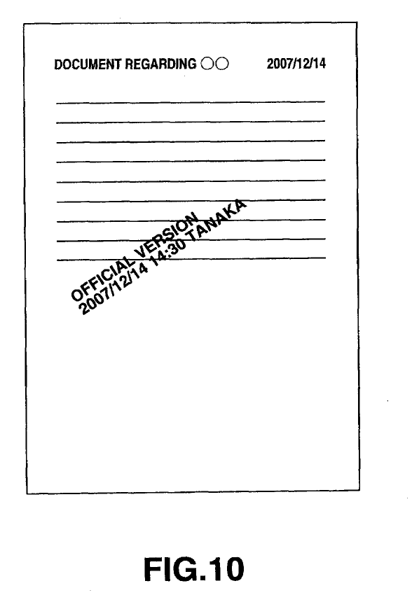

FIG. 10 is a diagram showing one example of the document sent from the printing image sending section 19 to the printer 4.

When the printing request reception section 8 receives from the PC 2 the document printing request, the document management device 3 lifts the prohibition on editing the background pattern information added to the document, which is acquired from the document storage 12 and is an object of the document printing request, and edits the content of the background pattern information so as to change from the content indicating that the document is not an official version into the content indicating that the document is an official version. As a result, by printing this document with the printer, the background pattern image indicating that the document is an official version as shown in FIG. 10 is printed out.

Viewing this document, a user can understand that an official document registered in the document management device 3 is printed out.

Note that the background pattern image printed to the printing image may have a size either covering the overall background or limited to a part of the background. As for the type, the background pattern image may be in a form where a character string appears by copying or in a form where a machine-readable code is printed on the background. Additionally, it may be possible to employ a form where the background pattern information is stored in an electronic tag such as RFID.

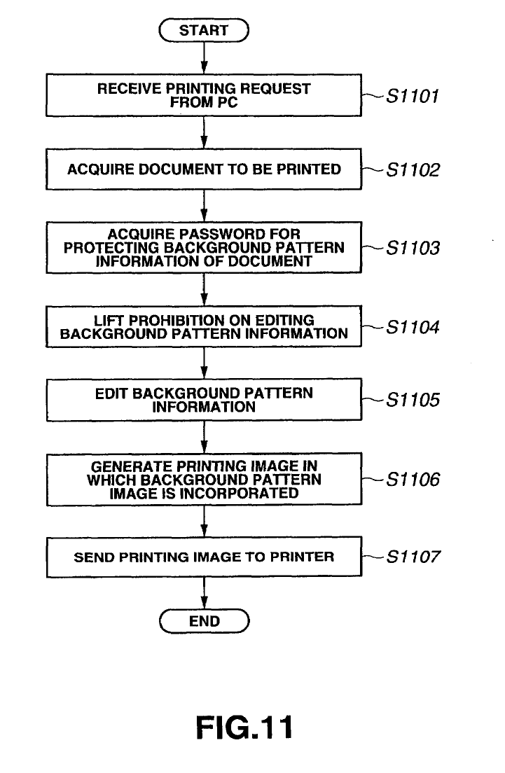

Next, one example of a flow processed by the document management device 3 at the time of document printing will be described with reference to a flow chart shown in FIG. 11.

After the printing request reception section 8 receives from the PC a request for document printing (S1101), the document acquisition section 14 acquires a document-to-be-printed from the document storage 12 (S1102), the background pattern information edition prohibition lifting section 16 acquires from the password storage 13 a password for protecting the background pattern information added to the document (S1103) and lifts the prohibition on editing the background pattern information by using the password (S1104), the background pattern information edition section 17 edits the background pattern information (S1105), the printing image generation section 18 generates a printing image into which a background pattern image is incorporated (S1106), the printing image sending section 19 sends the printing image to the printer (S1107), and the process ends.

The foregoing description of the exemplary embodiment of the present invention is provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document management device, comprising:
a document reception section that receives a document from a requestor through a communication section;
a background pattern information generation section that generates first background pattern information on which a first background pattern image is based;
a background pattern information addition section that adds the first background pattern information generated by the background pattern information generation section to the document received by the document reception section;
an edition prohibition setting section that sets, to the document, a prohibition on editing the first background pattern information added by the background pattern information addition section;
a document storage that stores the document having the first background pattern information added thereto;
a printing request reception section that receives, through the communication section from a requester, a request that an image formation device prints out the document stored in the document storage;
an edition prohibition lifting section that lifts the prohibition on editing the first background pattern information set to the document, which is an object of the request for printing received by the printing request reception section;
an edition section that edits the first background pattern information added to the document in which the editing prohibition is lifted by the edition prohibition lifting section to make second background pattern information on which a second background pattern image is based;
a printing image generation section that generates a printing image having the second background pattern image incorporated thereinto, on the basis of the document having the second background pattern information made by the edition section added thereto; and
a printing image sending section that sends, through the communication section to the image formation device, the printing image that is generated by the printing image generation section and into which the second background pattern image is incorporated.

2. The document management device according to claim 1, further comprising:
a document acquisition request reception section that receives, through the communication section from a requester, a request for acquiring the document stored in the document storage; and
a document sending section that sends the document having the first background pattern information added thereto, which is an object of the acquisition request received by the document acquisition request reception section, to the requestor through the communication section in a state where editing the first background pattern information is prohibited.

3. The document management device according to claim 1, wherein
the edition prohibition setting section comprises:
an authentication information generation section that generates authentication information for protecting the first background pattern information added to the document; and
an authentication information addition section that adds the authentication information generated by the authentication information generation section, and
the edition prohibition lifting section comprises a protection ineffective section that makes the protection for the first background pattern information ineffective by using the authentication information for protecting the first background pattern information set to the document, which is an object of the printing request.

4. The document management device according to claim 3, wherein
the authentication information includes information difficult to input from a general-purpose input device.

5. A document management method, comprising:
receiving a document from a requestor;
generating first background pattern information on which a first background pattern image is based;
adding the generated first background pattern information to the received document;
setting, to the document, a prohibition on editing the added first background pattern information;
storing the document having the first background pattern information added thereto;
receiving, from a requester, a request for printing out the stored document;
lifting the prohibition on editing the first background pattern information set to a document, which is an object of the received request for printing;
editing the first background pattern information added to the document in which editing prohibition is lifted to make second background pattern information on which a second background pattern image is based;
generating a printing image having the second background pattern image incorporated thereinto, on the basis of the document having the second background pattern information added thereto; and
sending the generated printing image having the second background pattern image incorporated thereinto.

6. A computer readable recording medium storing a document management program that causes a computer to execute a process, the process comprising:
receiving a document from a requestor;
generating first background pattern information on which a first background pattern image is based;
adding the generated first background pattern information to the received document;
setting, to the document, a prohibition on editing the added first background pattern information;
storing the document having the first background pattern information added thereto;
receiving, from a requester, a request for printing out the stored document;
lifting the prohibition on editing the first background pattern information set to a document, which is an object of the received request for printing;
editing the first background pattern information added to the document in which editing prohibition is lifted to make second background pattern information on which a second background pattern image is based;
generating a printing image having the second background pattern image incorporated thereinto, on the basis of the document having the second background pattern information added thereto; and
sending the generated printing image having the second background pattern image incorporated thereinto.

7. A computer data signal embodied in a carrier wave for enabling a computer to perform a process for document management, the process comprising:
receiving a document from a requester;
generating first background pattern information on which a first background pattern image is based;
adding the generated first background pattern information to the received document;
setting, to the document, a prohibition on editing the added first background pattern information;
storing the document having the first background pattern information added thereto;
receiving, from a requester, a request for printing out the stored document;
lifting the prohibition on editing the first background pattern information set to a document, which is an object of the received request for printing;
editing the first background pattern information added to the document in which editing prohibition is lifted to make second background pattern information on which a second background pattern image is based;
generating a printing image having the second background pattern image incorporated thereinto, on the basis of the document having the second background pattern information added thereto; and
sending the generated printing image having the second background pattern image incorporated thereinto.
